(19) United States
(12) Patent Application Publication
(10) Pub. No.: US 2016/0124920 A1
(43) Pub. Date: May 5, 2016

(54) Combination web browser based dental practice management software system with embedded web browser based dental imaging software

(71) Applicant: Douglas A. Golay, Coon Rapids, IA (US)

(72) Inventor: Douglas A. Golay, Coon Rapids, IA (US)

(21) Appl. No.: 14/530,614

(22) Filed: Oct. 31, 2014

(51) Int. Cl. G06F 17/22

(52) U.S. Cl. CPC G06F 17/2247; G06Q 50/24

(57) ABSTRACT

A combination dental imaging system and dental practice management and charting system includes a web browser based dental practice management software which includes patient charting capabilities and an encapsulated web browser based dental imaging software component. The encapsulated dental imaging software component includes a display of images suitable for diagnostic use. The encapsulated web browser based dental imaging software component is embedded into a disparate dental practice management system software web page. The combination dental imaging system and dental practice management and charting system also includes a communication interface which couples the web browser based dental imaging software component to the web browser based dental practice management system software. The web browser based dental practice management system software graphical user interface is updated with the capability to initiate display of the encapsulated web browser based dental imaging software component.

### BACKGROUND OF THE INVENTION

1. Field of the Invention

The present invention generally relates to combining dental imaging software with dental practice management software and more particularly to a system and method of embedding an encapsulated medically regulated decoupled web browser based dental imaging software component into a disparate non-FDA regulated web browser based dental practice management software.

2. Description of the Prior Art

Dental practice management systems have been used in dentistry since the rapid adoption of the personal computer which started in the 1980's. Originally, dental practice management systems emulated and replaced the existing dental office front desk paper systems in use previously by dentists and dental staff such as for accounting of patient bills and scheduling of patients appointments. Most dental practice management system's expanded their capabilities in the 1990's and 2000's and added features for the dentists and dental staff in either the back office or the operatory which included an electronic version of the paper dental chart. Electronic Dental charting allows the dentists to create an electronic record of patients existing dental conditions, in addition to procedures completed or in-process by the dental office on this patient; as well as optionally treatment planning for the patient showing various treatment options.

Dental imaging systems have been commonly in use by dentists since the late 1980's including intraoral video cameras. In the 1990's and 2000's digital x-ray technology for intraoral and extraoral x-rays had rapid adoption by dental practices. It is estimated that as of 2014, approximately 80% of dentists in the USA employ some form of digital x-rays.

During this entire timeframe and indeed even today most dental practice management system and dental imaging systems have remained separated disparate (decoupled) and isolated systems from each other. There has been minimal integration of these two disparate systems and this has complicated and limited the capability and interaction of such systems when used by dentists and their staff.

Some practice management software companies allow bridging to separate dental imaging software. Bridges between practice management software and dental image software and systems typically interchange only minimal information such as patient name and ID. Even with bridging; multiple additional steps are typically required to interact with both separate softwares to complete a task that they may have in common such as attaching an image generated by the dental imaging system to either a claim form or an electronic chart generated by the dental practice management software.

In some cases very large companies have acquired and/or have exclusive rights to both practice management software and a specific brand of dental imaging software/system and there has been some attempt at improving interaction between the two disparate softwares. Some practice management software's can semi automate the retrieval of images from a specific dental imaging software for inclusion into an e-claim form; and without the user required to export from one software and import into the other manually. Even in these cases though, different user interfaces, multiple open windows, multiple points of failure and multiple databases limit the interaction and reliability of the system.

In the optimal scenario from a system and users perspective the practice management software and the dental imaging software would be a single unified software with a consistent workflow, consistent GUI, unified database, common data structures, and ability to interact with all data and information generated by either the regulated dental imaging software or the non regulated practice management software. But contrary to that, from a cost and development perspective a single unified software is not optimal because dental imaging software and systems are regulated by the FDA (in the USA) and require quite extensive documentation and adherence to regulations such as Quality System Reporting (QSR) and the applicable regulations in the Code of Federal Regulations (CFR) for class II medical devices and which includes dental imaging software. If either dental imaging software or a source code is combined into a single software with the practice management software there exists no separation of concerns between the practice management software and either the dental imaging software or the systems and therefore the entire combined software would be subject to the FDA documentation and applicable medical device requirements. The extensive extra burden and costs added by requiring class II medical software compliance for the practice management software is highly undesirable for manufacturers of dental practice management software. Because of the above and other reasons, none of the established dental practice management software's offer a single unified practice management and dental imaging software. Instead, dental practice management software companies try to implement either a floating window of thumbnails or text information generated by disparate imaging software and which is placed on top of the practice management software window for display and/or the practice management software displays an image thumbnail in the practice management software that is not floating on top of its window and that was generated by the disparate imaging software. When a user clicks on the thumbnail or text described above, which was generated by the imaging software, the disparate imaging software launches and is either overlaid or placed on top of the practice management software window. While this method works and is an improvement over a standard bridge with no automation, it is far from optimal. As methods of software development and deployment advance many software's are moving to the cloud. Such web browser based software's are typically hosted on software servers and delivered via an internet or intranet connection, have the ability to operate upon a broader range of client hardware including hardware running on operating systems from Microsoft, Apple, or Linux, and which are accessible from any location with an internet connection. This type of technology has the promise of reducing installation, maintenance, and physical hardware requirements at the local dental office and is managed remotely via trained IT personnel. However, standard Web-browsers using HTML and Javascript are quite limited in capability and power as compared to modern client server software's which are created with powerful compilers and targeted to specific operating systems. The limit of web-browser capability and the associated development tools highly complicates the interaction and workflow of a web based dental imaging software and web browser based dental practice management software when desired to be used together seamlessly.

The previous methods of either interaction or integration used by local (either client or server) dental practice management software with local (either client or server) dental imaging software including bridges and/or floating windows and/or thumbnail display doesn't visually work as desired for users of web browser based software's in that the web-browser based imaging software is visually displayed in another non-associated web page (usually a tab the user must click on) and with minimal programmatic control on the size, appearance, and location of the browser window containing an image; and which therefore highly compromises the users workflow. Also, the existing local (either client or server) dental imaging and practice management software's methods of integrations do not offer full imaging capabilities accessible from within the practice management software including diagnostic viewable images, either image enhancement or processing tools for the images and direct acquisition of new images. The practice management software user interface is limited to displaying non diagnostic thumbnails only which must be selected to launch the disparate dental imaging software for any tasks involving diagnostic image viewing, applying image processing tools, or acquiring new images. The local (either client or server) dental imaging and practice management software's methods of integration neither allow the practice management software to display and diagnose a clinical image while remaining (visually from a user's perspective) in either the practice management software or the chart nor allow image processing tools to be applied and viewed such as a periodontal or endodontic filter to aid in diagnosis of a digital X-ray image which has been generated by the disparate dental imaging software/system. Because the practice management software manufacturers do not want to become medically regulated (FDA is USA) software they do not automate viewing of full size diagnostic images from within (visually) the practice management software and do not allow display of the images in the same window as the practice management software. Requiring users to switch between multiple disparate software is not optimal. What is needed is an encapsulated medically regulated decoupled web browser based dental imaging software that can be embedded into a disparate non medically regulated dental practice management software without causing the web browser based dental practice management software to become a FDA regulated software. In addition, there needed to be invented a method to display full diagnostic dental images from within the dental web-browser practice software window; allowing direct interaction with images generated by the disparate dental imaging software without changing (from either visual or user's perspective) to another software.

US Patent Publication No. 2014/0143298 teaches a system for zero footprint medical image-viewing which includes a zero footprint viewer including a display pipeline to render and provide image content to a client device without particular configuration of the client device to display and facilitate manipulation of the image content via a client browser. The system also includes a middle-tier server to retrieve the image content from storage and to convert the image content from a stored format to a browser-convenient format. The zero footprint viewer includes a first data manager to gather image content from the middle-tier server, and the middle-tier server includes a second data manager to retrieve the image content and format the image content from the stored format to the browser-convenient format, the second data manager to communicate with the first data manager to facilitate transfer of the image content for display. Prior to the rapid onset of digital imaging, patient images were “printed” to film. The film was “hung” and viewed by radiologists, who would then dictate a report. Reports were transcribed by individuals ranging for administrative staff to medical transcriptionists and sent to ordering physician via mail or fax. Critical results were delivered by phone or pager and business statistics were managed via paper reports and spreadsheets. As information systems for radiology came to market, the first commercially available solutions addressed the needs of the radiologist and the radiology department. These included Radiology Information Systems (RIS) and dictation transcription systems. RIS systems managed the ordering, scheduling, patient and management reporting processes while radiologists were still reading from film. As modalities started to support the digital display of images on workstations connected to the acquisition device, Picture Archiving and Communications Systems (PACS) came to market. These centrally store images and provide radiologists with the tools to read studies on networked computer monitors, replacing both film and modality workstations. Over time, the needs of the market have evolved from supporting specialized radiologist workflows to supporting the open and dynamic needs of the enterprise and the community. The vendor community has added systems to manage the need for advanced technologies for better diagnosis; the sharing of images between providers and organizations; to support collaboration between radiologists, physicians and teams providing care for the patient; to close the loop on reporting of critical results and manage the growing storage requirements. Often these are disparate, best-of breed systems that may or may not interoperate, increasing cost and decreasing productivity.

US Patent Publication No 2012/0253848 teaches a system which integrates different applications like imaging system, audio-video streaming system, Electronic Medical Records (EMR), Electronic Health Records (EHR), Patient Health Records (PHR), PACS (Picture Archiving and Communication System), Lab System and patient monitoring systems, databases or warehouses into single application, wherein all the applications are displayed in a single computer screen/interface preferably by using a common interaction platform such as a web browser. The web browser provides the patient direct interface in real time with the health care professional. The system enables standardized data, records and content of patients, store the information captured into integrated application database and/or into its objects stored in the application folders. The system integrates different applications like image archiving system, audio-video streaming system, Electronic Medical Records (EMR), Electronic Health Records (EHR), Patient Health Records (PHR), PACS (Picture Archiving and Communication System), Lab System and patient monitoring systems/databases/warehouses into single application, wherein all the applications are displayed in a single screen/interface in order to read and write to these systems/applications if authorized. The platform provides integrated application interface by way of a web browser in a single computer screen. Healthcare environments, such as hospitals or clinics, include clinical information systems, such as hospital information systems (HIS), radiology information systems (RIS), clinical information systems (CIS), and cardiovascular information systems (CVIS), and storage systems, such as picture archiving and communication systems (PACS), library information systems (LIS), and Electronic Medical Records (EMR) or Electronic Health Records (EHR). Information stored may include patient medical histories, imaging data, test results, diagnosis information, management information, and/or scheduling information. The information may be centrally stored or divided among a plurality of locations. Healthcare practitioners may desire to access patient information or other information at various points in a healthcare workflow. During surgery, medical personnel may access patient information, such as images of a patient's anatomy, which are stored in a medical information system. Alternatively, medical personnel may enter new information, such as history, diagnostics, or treatment information, into a medical information system during an ongoing medical procedure. In a healthcare workflow, healthcare providers often consult or otherwise interact with each other. Such interaction typically involves paging or telephoning another practitioner. Thus, interaction between healthcare practitioners may be both time-consuming and energy-consuming. Current advances in technologies related to Medical/healthcare delivery services use one or more applications to review a patient history, medical information and record information during interactions. The state of the applications today is disparate and requires un-friendly actions by the users to obtain information. In order to review images within a imaging system (e.g. PACS—Picture Archiving and Communication System) while reviewing/updating medical records in an electronic medical records (EMR), the medical user will have to close EMR, login into PACS, review images, print/hand write information, close PACS, re-login into EMR and enter the collected information. Current healthcare information technology software applications do not afford to annotate, comment or collaborate on specific patient information. Current systems allow for communication via email, whereby screen captures with annotations are attached to the email. Unfortunately, email systems are not integrated with EMR applications so that the comment threads can be stored for historical reference. Thus, systems and methods for improved annotation, comment and collaboration would be highly desirable. Systems and methods allowing discussion threads and annotations to be stored with an EMR would also be highly desirable. The process is time-consuming, inefficient and impairs productivity of the medical professionals. In results, healthcare delivery if costly and valuable time is lost in order to provide medical services to a needy patient.

US Patent Publication No 2012/0216132 teaches embedding user selected content in a web browser display, including receiving, by a web browser from a user, a selection of a display object to persistently display for each of a number of subsequently accessed documents to be displayed by the web browser: retrieving, by the web browser, the document from a document source; embedding, by the web browser, the user-selected display object in the document through a document management API exposing one or more interfaces for managing documents; and displaying, by the web browser, the document with the embedded user-selected display object. Web browsers are becoming increasingly more useful to users. Moreover, resources relied upon by users are increasingly moving from locally accessible locations to remote locations accessible by web browsers. As such, users' reliance on web browsers is increasingly rapidly. At present no web browser provides a means by which a user may select an object to persistently display while navigating the Web.

US Patent Publication No 2012/0198361 teaches a networked computer system which provides seamless navigation among a plurality of web applications. The networked computer system includes a server serving a plurality of applications and a client-side computer system connected to the server over a network. The client-side computer system includes a browser configured to access the plurality of applications. The browser includes a plurality of frames, each executing an interface configured to access a respective one of the plurality of applications over the network. The browser provides seamless navigation among the plurality of applications. The method includes steps of receiving a webpage comprising a plurality of interfaces to a plurality of applications, rendering the webpage within a browser, and seamlessly navigating from a first one of the interfaces to a second one of the interfaces in response to a user selection. Seamless navigation may be effected by hiding the first interface while un-hiding the second interface. A computer interface provides for seamless integration of a plurality of web applications to a web browser which provides access to a plurality of web applications in a plurality of frames and which provides for seamless navigation from one web application accessed in one frame to another web application accessed in another frame. Large enterprise software systems often include numerous enterprise applications. In some cases, enterprise software systems include so many enterprise applications that it has become very difficult to determine where one application, e.g., enterprise resource planning (ERP), ends and another begins, e.g., supply chain management (SCM), product lifecycle management (PLM), customer relationship management (CRM) and enterprise asset management (EAM).

US Patent Publication No 2011/0282936 teaches a smart network which includes a smart network host device as well as one or more client devices configured to connect to the smart network. Each of the client devices may implement one or more services that the client device exposes to other devices connected to the smart network. Each of the client devices includes network layer 2 and 3 attributes as well as network layer 7 application attributes. The application attributes are enumerated as named services, which each client device registers with the smart network host device. When a client device needs access to a named service, the smart network host device uses layer 2, 3, and 7 attributes associated with the client device to select a suitable server for providing the named service to the client device. Home networks, in which multiple computing and/or peripheral devices are communicatively linked together in a consumer's home, are becoming increasingly ubiquitous. A home environment may include one or more computers, a wireless router, a cable modem or digital subscriber line (DSL) modem, and one or more other devices capable of connecting to the home network. Conventionally, each device in the home network must be manually configured to connect to the network and, once connected, may then communicate with other devices attached to the home network. Each connected device may offer different services to the other devices within the network or require certain services from other devices within the network. Conventionally, each device and related service must be manually configured to operate properly with other devices offering or using a certain service. Manual configuration can technically enable devices to operate together in a given network. In practical settings, however, procedures for establishing and provisioning services within a home network are typically too involved for the majority of home network users to implement reliably. A network user may need to manually reconfigure a home network router, determine a network IP address and/or hostname for each device, establish network credentials, register a networked video monitor device and a home surveillance camera, pair the monitor device with the camera, and so forth. Furthermore, in order for a device to locate another device on the home network, a device must establish communication using a unique IP address of the other device. Such connections are typically defined as peer-to-peer connections. In peer-to-peer applications, a user may be required to manually keep track of which address is associated with which device or service in order to configure the devices to communicate properly. Such manual configuration procedures present a significant challenge for unsophisticated users attempting to set up a home network and provision services on the home network.

Accordingly, there is a need in the art for systems and methods that reliably and conveniently enable the user of a home network to automatically configure and provision services provided by one or more client devices on the home network.

US Patent Publication No. 2009/0094514 teaches an ability to embed and edit rich content into a browser document. Embedded objects are not backed by installed desktop applications. Instead, in one embodiment, the embedded objects are Asynchronous Javascript and XML (AJAX) components that adhere to a set of design patterns, which are embedded within editable HTML documents. A user composing an email message can embed a spreadsheet into the email. The spreadsheet is implemented, in one embodiment, as an AJAX component adhering to the Ajax Linking and Embedding (ALE) design pattern. Since it is an ALE component, the embedded object is fetched across the network so that it may be instantiated and used regardless of the user's location. The user can edit, manipulate, and save the embedded object while remaining in the context of the container document. One of the key features of modern word processors like Open Office from Sun Microsystems (Santa Clara, Calif.) and Microsoft Word from Microsoft Corp. (Redmond, Wash.) is the ability to embed higher order objects into a document. While editing, it is possible to embed a chart, picture, spreadsheet, or other rich content into the text document. It is possible to edit the embedded content while remaining within the context of the word processing application. In a desktop environment, this is typically accomplished by invoking the host application used by the embedded object (e.g., a spreadsheet application if the embedded object is a spreadsheet). The user experience in such an instance is that the embedded object becomes editable and the functions of the application used by the embedded object become available to the user while he is editing the object. It is possible to embed different documents and/or objects (possibly based on different desktop applications) within one document. For instance, a user can embed a spreadsheet created in Microsoft Excel and a document created in Adobe Acrobat from Adobe (San Jose, Calif.) within a document created using Word from Microsoft. When a user later wishes to edit or modify any of the embedded objects, he simply double-clicks on the embedded object, whereupon the corresponding desktop application (e.g., Microsoft Excel) opens up on the user's computer, and the user can then proceed to edit the embedded object within the application that was used to create it. Any changes made to the object are saved, and are reflected in the container document such as a Microsoft Word document. This capability has typically been enabled by using a component embedding model such as Microsoft's COM/DCOM or IBM's DSOM and has been strictly within the domain of fat desktop applications and office suites. This functionality is based upon Object Linking and Embedding (OLE) technology. OLE is a distributed object system and protocol developed by Microsoft. OLE takes advantage of and is a part of the larger, more general concept, the Component Object Model (COM) and its distributed version DOOM. OLE allows an editor to send out part of a document to another editor and then reimport it. OLE is based upon a fat client architecture, which means that the file type or the application which is being embedded must be present on the machine which is being operated upon. For instance, if a Microsoft Excel spreadsheet is to be manipulated or even viewed, then there must be a copy of Excel or an Excel viewer installed on the user's machine. The concept of embedding is also used in the context of multimedia in Web pages, where video, animation (including Flash animations), and audio files are embedded within the hypertext markup language (such as HTML or XHTML) or other structural markup language used (such as XML or SGML). However, in these instances, it is not possible to modify the embedded content while remaining within the context of the container document, and to save the changes, so as to have those changes be seamlessly reflected while remaining within the context of the container document in which the content is embedded. There is a need for a method and system for embedding objects within a browser window, and for seamlessly editing, saving and restoring objects within the browser window, where the embedded objects are not supported by underlying desktop applications which need to be present on the user's machine.

US Patent Publication No 2006/0136843 teaches a method of dynamically controlling and displaying an Internet browser interface and a dynamically controllable Internet browser interface. A browser interface may be customized using a controlling software program that may be provided by an Internet content provider, an ISP, or that may reside on an Internet user's computer. The controlling software program enables the Internet user, the content provider, or the ISP to customize and control the information and/or functionality of a user's browser and browser interface. When accessing the Internet such as the worldwide web an Internet user typically executes, via a computer, a browser software program such as either Netscape Navigator or Microsoft Internet Explorer. Either the browser program or the browser establishes a physical link to the Internet via a modem and an Internet Service Provider (ISP) and also provides a textual and graphical user interface, i.e., a browser interface, having a predetermined look and functionality, neither of which can currently be significantly changed by the Internet user. Thus, the browser interface remains relatively static as the Internet user navigates the Internet and moves from application to application or HTML (Hyper-text Mark-up Language) page to HTML page. Limited control of the browser interface is currently available via an executable software program that may add functional buttons to the interface. However, the additional functionality is added to the browser interface when the browser is initially activated and remains static thereafter. Thus, it is not possible for a browser displaying a browser interface modified as just-described to dynamically download information from an Internet site and customize itself, either when the browser is initiated or as the users traverses the Internet. Such a modified browser interface also does not provide access to the various browser Application Programming Interfaces (APIs) for Plug-ins and interfaces. The proliferation of Internet sites makes it increasingly difficult for content providers (i.e., owners of Internet sites) to maximize the time an Internet user spends at a particular Internet site. It is, of course, desirable for a content provider to be able to maximize that time an Internet user spends at that provider's Internet site, or to ensure that an Internet user returns to the content provider's site; this being generally referred to in the art as stickiness. It is also desirable to maximize the number of Internet users accessing a content provider's site. An Internet content provider wants to attract a maximum number of Internet users to that provider's Internet site, and to maximize the amount of time those Internet users remain at that site; neither of which is possible using current Internet browsers.

U.S. Pat. No. 8,738,396 teaches an integrated medical software system with embedded transcription functionality which includes a clinical software module that is configured to be executed by a processor to create an electronic document and to capture clinical data for a patient in the electronic document during an encounter with the patient. The system also includes a transcription software application that is configured to be executed by the processor to select predefined clinical data that will appear within the electronic document in response to speech commands and to automatically transcribe dictated clinical data that will appear within the electronic document in response to dictation, wherein the predefined clinical data being previously linked to at least one of a diagnosis code and a procedure code and the dictated clinical data being automatically linked to at least one of a diagnosis code and a procedure code as it is transcribed. And the system includes an account management software module that is configured to be executed by the processor to automatically generate at least one of a bill, a claim, or a statement for the patient using the at least one of a diagnosis code and a procedure code linked to at least one of the predefined clinical data and the dictated clinical data. The medical software system integrates all aspects of practice management, managed care, and medical research. The integrated medical software system with embedded transcription functionality increases the efficiency of data capture and flow within that system. Healthcare providers have kept all of their patients' information in paper filing systems. That patient information includes, but is not limited to, patients' demographic information (e.g., age, weight, gender, race, income, and geographic location), financial information (e.g., outstanding balances, insurance claims currently being processed, and other account information), and clinical information (e.g., clinician documentation of observations, thoughts and actions, treatments administered, patient history, medication and allergy lists, vaccine administration lists, laboratory reports, X-rays, charts, progress notes, consultation reports, procedure notes, hospital reports, correspondence, and test results). The healthcare providers, or clinicians, that maintain that patient information include, but are not limited to, physicians (Doctors of Medicine (MDs) and Doctors of Osteopathic Medicine (DOs)), dentists, chiropractors, podiatrists, therapists, psychologists, physician assistants, nurses, medical assistants, and technicians. The manual, paper-based practice of keeping a patient's information, however, is a very inefficient, labor-intensive process that requires many checks and balances to ensure accurate processing of the information and, therefore, takes up a significant amount of clinician's time that could otherwise be spent with patients. Accordingly, electronic medical records (EMRs), Electronic Health Records (EHRs), and Personal Health Records (PHRs) have been developed to provide many of the functionalities and features of paper filing systems in an electronic, paperless format. An EMR is an electronic record of patient information that can be created, gathered, managed, and consulted by the authorized clinicians and other staff at the healthcare practice where the record is created. An EHR is an electronic record of patient information that conforms to nationally recognized interoperability standards and that can be created, managed, and consulted by authorized clinicians and staff, both at the healthcare practice that creates the record and at other healthcare practice sites. And, a PHR is an electronic record of patient information that conforms to nationally recognized interoperability standards and that can be drawn from multiple sources while being managed, shared, and controlled by the patient to whom it belongs. Accordingly, EMRs are aimed primarily at the efficient management of multiple records in a single healthcare provider's practice, while EHRs and PHRs are aimed primarily at integrating multiple data sources into each electronic record. The nationally recognized interoperability standards for EHRs are currently endorsed by the Healthcare Information Technology Standards Panel (HTISP) and certified by the Certification Commission for Healthcare Information Technology (CCHIT). Those standards require EHRs to have the ability to communicate and exchange data accurately, effectively, securely, and consistently with different information technology systems, software applications, and networks in various settings such that the clinical or operational purpose and meaning of the data are preserved and unaltered as that data is exchanged. Thus, while an EMR is generally characterized as an electronic version of a physician's paper record, an EHR is characterized as a more comprehensive record containing additional data integrated to and from other sources. EHRs are further characterized as being either “basic” or “fully functional.” A basic EHR includes patient demographics, problem lists, clinical notes, orders for prescription, and viewing laboratory and imaging results. A fully functional EHR includes patient demographics, problem lists, clinical notes, medical history and follow-up, orders for prescriptions, orders for tests, prescription orders sent electronically, laboratory and imaging results, warnings of drug interactions or contraindications, out-of-range test levels, and reminders for guideline-based interventions. At their core, EMR and EHR systems include large-capacity databases that contain patient information stored in structured, relational tables of searchable data. Unfortunately, many of the vendors of EMR and EHR systems have resisted making their software capable of exporting and importing patient information using uniform electronic messaging, document, and form management standards such as the Health Level Seven (HL7) messaging standard, the Continuity of Care Document (CCD) document standard, and the Retrieve Form for Data Capture (RFD) form management standard. When data is not captured and stored using uniform, standardized medical vocabularies, and when it is not transmitted using uniform messaging, document, and form management standards, that data of little use outside of the system in which it is captured and stored. Instead, custom interfaces must be designed to allow the import and export of data between systems so that data can be shared between those systems. The process of developing different interfaces between the disparate formats used by different vendors is expensive and difficult. Moreover, such interfaces are also costly and labor-intensive to maintain. The problem of interfacing different EMR and EHR systems is exacerbated by the fact that, in the present health care industry, most patient visits are to small, self-contained practices that often treasure their autonomy and are unwilling and/or unable to acquire EMR and EHR systems unless each of those systems is individually tailored to the narrow objectives of each specific self-contained practice. Most EMR and EHR vendors have been forced to provide healthcare practices with individually customized systems that employ stand-alone features and functions on the basis of what a specific practice group wants and needs, which means that similar practice groups in adjacent counties may have very different system features and functions based on their different priorities. Thus, the various existing EMR and EHR systems are not well suited for interaction and data exchange with each other, or for maintaining information that would be useful to other systems. The data collected by the different practice groups using EMR and EHR systems is therefore severely fragmented. Most of the commercially available EMR and EHR systems have not been well received by healthcare providers. In fact, according to a 2008 survey conducted by the National Center for Health Services (NCHS), a division of the Centers for Disease Control and Prevention (CDC), while about 40% of U.S. office-based physicians reported using EMR systems, only 17% reported using basic EHR systems, and only 4% reported using fully functional EHR systems. Healthcare providers tend to resist such systems because those systems are unable to keep up with the workflow demands of clinicians during the various tasks they perform throughout the day. Traditional EMR and EHR systems are generally technology-driven, as opposed to being user-driven. Accordingly, healthcare providers find them difficult to use, especially those healthcare providers that have difficulty with computer technology, and especially when it involves adopting new software with which the healthcare provider is not already familiar. Many healthcare providers would rather focus solely on patient care than be bothered with learning how to operate the latest computer technology. In an attempt to gain wider acceptance of EMR and EHR systems, some health information technology (HIT) engineers have developed user interfaces to help ease healthcare providers' transition into the electronic record-keeping medium. Because healthcare is a dictation-intensive field, some HIT engineers have adopted a speech recognition approach for interfacing with EMR and EHR systems. That approach allows healthcare providers to dictate information as they traditionally have done, except that the information is captured in a computer-readable medium (e.g., an XML file) that can be input directly into EMR and EHR systems. Two different types of speech recognition technology have been developed to help ease healthcare providers' transition into the electronic record-keeping medium and improve turnaround time in generating electronic patient records-back-end speech recognition and front-end speech recognition. Back-end speech recognition generates an electronic text document in the background as a healthcare provider dictates without the healthcare provider being able to see or edit, and oftentimes without the healthcare provider even being aware of, what is being transcribed in the electronic text document. The resulting electronic text document, along with the corresponding voice file, is then sent to a medical transcription/editing service that reads the electronic text document, listens to the voice file, and corrects any mistakes (recognition and/or dictation) in the electronic text document. The medical transcription/editing service then returns the corrected electronic text document to the healthcare practice for entry into an EMR or EHR system. The medical transcription/editing service may also enter the appropriate information into the EMR or EHR system themselves. If the information captured by back-end speech recognition is used to generate documentation that requires the healthcare provider's signature such as progress notes, consultation reports, procedure notes and hospital reports that documentation will also need to be provided to the healthcare provider for review and signature. The turnaround time required for a medical transcription/editing service to review and correct the electronic text document is unpredictable and inconvenient. Using such services also creates an additional expense for healthcare providers, who already suffer from large overhead costs. Front-end speech recognition provides faster turnaround times and eliminates the need for medical transcription/editing services by allowing the healthcare provider to view and edit the electronic text document as it is generated. Thus, instead of using medical transcription/editing services to review and edit the electronic text document, the healthcare provider can immediately see and correct any mistakes (recognition and/or dictation) in the electronic text document Like traditional EMR and EHR systems, however, traditional front-end speech recognition is often provided as separate software that must be interfaced with the EMR or EHR system with which it is being used. Thus, unlike back-end speech recognition running in the background, healthcare providers must familiarize themselves with, and ultimately accept, that new software platform for it to be of any beneficial use. Although back-end speech recognition does not require healthcare providers to familiarize themselves with and accept new software, neither the software used to provide traditional back-end speech recognition nor the software used to provide traditional front-end speech recognition incorporates uniform electronic messaging, document, and form management standards to import and export the information captured therewith. Instead, the information captured by that software is typically only used to complete the specific clinical documentation for which it was captured (e.g., progress notes, consultation reports, procedure notes, hospital reports, etc.) rather than being provided in a format that can be used for other purposes, such as data collection and analysis for practice management and medical research. And, as discussed above, when data is not captured and stored using uniform, standardized medical vocabularies, and when it is not transmitted using uniform messaging, document, and form management standards, that data is of little use outside of the system in which it was captured unless custom interfaces are designed to connect that system to other systems. Much less, it is of little use outside of the document for which it was captured. Another shortcoming of conventional speech recognition technology is that such technology requires a significant amount of voice recognition training by a user for the speech recognition to be accurate. A user will be required to dictate several passages into a computer to “train” the voice recognition software on that computer to recognize that user's voice and mannerisms. A “voice profile” is created for that specific user based on that training. The user must either save that voice profile to a portable electronic storage medium such as either a CD-ROM or zip disk or perform the training again whenever that user uses a different computer, or accesses the computer remotely, to dictate speech. Management of a user's voice profile can become problematic and burdensome when a user frequently uses different systems to dictate speech. Because most EMR and EHR systems and the speech recognition software with which they are interfaced are not capable of exporting and importing patient information in a standardized format, and because they do not utilize functions and features suited for interaction and data exchange with other systems, the fragmented pools of data collected using those systems cannot easily be combined. Accordingly, an individual healthcare practice cannot share data between its individually customized systems in a way that streamlines management of that healthcare practice, but instead must capture, store, and manage duplicate sets of data between its disparate, stand-alone systems. Moreover, researchers cannot easily collect data from multiple healthcare practices for performing medical research, maintaining disease registries, tracking patient care for quality and safety initiatives, and performing composite clinical and financial analytics. Instead, those processes remain time-consuming and expensive. A clinical research organization (CRO) tasked with identifying patients that satisfy specific criteria for participating in a clinical trial must still sort through voluminous libraries of paper medical records and unstructured data, spending large amounts of time and money searching for candidates. Those problems are compounded by the regulations of the Health Insurance Portability and Accountability Act (HIPAA). The implementation of the regulations of HIPAA has increased the overall amount of paperwork and the overall costs required for healthcare providers to operate. And the complex legal implications associated with those regulations have caused concerns with compliance among healthcare providers. With regard to researchers, the HIPAA regulations have hindered their ability to perform retrospective, chart-based research as well as their ability to prospectively evaluate patients by contacting them for follow-up surveys. The HIPAA regulations have also led to significant decreases in patient accrual for research, increases in time spent recruiting patients for research, and increases in mean recruitment costs. And by requiring that informed consent forms for research studies include extensive detail on how the participant's protected information will be kept private, those already complex documents have become even less user-friendly. There is a need for a medical software system that seamlessly integrates the systems required to manage the different activities performed at a healthcare practice (i.e., an EMR or EHR system, a patient registration system, a scheduling system, an account management system, a billing system, etc.) so that duplicate and/or inconsistent data is not captured, stored, and managed by disparate, stand-alone systems. There is also a need for that integrated medical software system to include embedded speech understanding functionality for capturing data in a cost-effective and user-friendly manner. And there is a need for a plurality of such systems for systematically analyzing, collecting, and tracking patient data across a vast patient population (e.g., a community, region, state, nation, etc.) while complying with HIPAA regulations.

U.S. Pat. No. 8,307,299 teaches a virtual office management system which has an image output module that displays as a single view web page. A series of defined sections are included in the single view web page, a defined section being a divisible frame capable of displaying separate content within that divisible frame, a physical office module, a desktop module, and a resource module. The physical office module is connected to the single view web page and displayed within the divisible frame, the physical office module providing a layered physical office environment with tags assigned to file directories. The desktop module is connected to the single view web page and displayable through the divisible frame, the desktop module being linkable to content of a pre-determined file directory that is then displayed as a system file folder, and changeable through assigned tags associated with the layered physical office environment. The resource module is connected to the single view web page through a series of separate embedded links, the links individually layered into another frame of the single view web page and connected to both internal and external content. A virtual office management system allows a user to monitor and manage staff member work through a user-friendly three-dimensional Graphical User Interface (GUI). Increased technology and corporate globalization necessitate better management of information and staff members across many different boundaries. Information is spread across servers and databases, generally accessed through different software systems. Employees are in different time zones and are required to communicate with each on a more consistent basis. It is a primary challenge of management to facilitate a clear communication of ideas between these staff members, while providing staff members with the resources and information they need to complete assigned tasks. Companies have developed intranet systems that utilize internet protocols and network connectivity to securely share information or operational systems with its staff members. However, typical intranet presences are deployed on a separate web servers in order to have rich functionality. Management of information on these servers is not always readily available and strains system resources. Combining existing hardware and software into an integral office management system that enables remote access to the tools and/or information has been long desired. Office management systems have been developed that are in the form of a three-dimensional graphical user interface (GUI) for navigating within a virtual office environment. This allows the user, especially a manager, to have an integrated view of the office environment enabling better communication and information management. Employing a three-dimensional GUI provides these solutions with some connection to the physical environment to provide an intuitive grasp of resources, operation, and information available.

U.S. Patent Publication No. 2007/0192727 discloses a method for a virtual workspace comprising a three-dimensional user interface in which applications are accessed via user interaction with three-dimensional images. The method comprises a layer that allows a user to interact with 3-D objects to complete normal tasks and access physical assets. One embodiment of the reference provides information to a user in a fashion that is consistent with how a user would normally acquire corresponding information in the physical world.

US Patent Publication No. 2007/0192727 teaches a method for a virtual workspace comprising a three-dimensional user interface in which applications are accessed via user interaction with images of three dimensional shapes, this system presents a problem in that is lacks management of information across servers, supervision and interaction with staff members.

US Patent Publication No. 2008/0183483 teaches management software which includes a web-based custom map application that links relational databases to a browser rendering format layout map that shows physical locations and relationships among people, rooms and other assets, and further teaches that the user first develop relational databases through information gathering. However, any information that is linked to the visual assets must be prepared prior to use. This system is purely a database front end or graphical user interface (GUI) that lacks the ability to link to present information found on a network server, which further facilitates supervision and interaction with other staff members.

US Patent Publication No. 2004/0109031 teaches a customizable three-dimensional graphical user interface that allows for complete access to an existing computer operating system, applications and files, as well as the internet and on-line web portals. The software application automatically scans a computer user's hard drive and dynamically creates a customized three-dimensional environment that allows intuitive access to all of the user's computer functionality. In a preferred embodiment, the three-dimensional graphical user interface installs as the active desktop on a PC, replacing the user's “wallpaper” with the three-dimensional graphical user interface significantly increasing the viewing area and allows improved productivity and access to information. The three-dimensional desktop can actually look like an office where software applications and operating system functions are represented as realistic three-dimensional icons. A calculator program can be accessed by clicking on the calculator on the desk, a word processing document can look like actual paper documents, the weather outside can be based on today's weather forecast, and the radio accesses an Internet radio station. Although this graphical user interface allows for complete user access to an existing computer operating system, applications and files as well as the internet and on-line web portals, the reference only teaches intuitive access to a single user's computer functionality. The reference presents a problem in that it lacks desirable computer networking and monitoring features. Many information management solutions, even the ones discussed above, fail to facilitate staff member supervision and network interaction. Presence awareness is one type of tool that can provide better communication with staff members. Information management solutions, unless they are server deployed, do not provide a rational file storage scenario for minimizing email traffic and cost. Companies have long desired a platform that enables staff members to communicate more efficiently in order to limit system resources, yet provide structure that gives managers and workers ready access to all the disparate resources available to them. Currently, it takes multiple software systems and applications to access people, resources, and documents. Integrating a combination of these features has been challenging. An end-user, such as a manager, needs to control various aspects of the office environment. Providing a single integrated user friendly single view web page that integrates software systems and applications, wherein the end-user may manage and monitor staff members, assets, as well as documents, would be advantageous. It is desirable to accomplish this with a minimum of clicks and without navigating away from a single page.

U.S. Pat. No. 6,041,362 teaches a system which integrates disparate information technology applications and platforms across an enterprise and which provides a web client interface that associates with an enterprise network. Connecting with the web client through the network is the Hyper-Text Transfer Protocol (HTTP) server that includes a Common Gateway Interface (CGI) interface program for augmenting the integration of the disparate applications and platforms via remote and local applications execution. The HTTP server is specific to the particular enterprise for specifically dealing with application servers and information servers and further for collecting information and gathering it together into a form that is then displayed on the web client. The method obtains, processes, displays information and method and integrates disparate information technology applications and platforms across an enterprise that permits remote application execution and information delivery, local application execution from a remote application library, and a variety of other services through a single user interface. Corporations have many disparate new and old or existing applications that generally have been developed as stand-alone functions. Information technology systems may have been written by or for the accounting department, the shipping department, or the order entry group and often have different designs and user interfaces, different applications, and run on different platforms. They also are often stored in many different, and different types of, data bases. The stand-alone functions can require different interfaces and login identifiers for each function, the use of multiple network navigation functions (i.e., searching for the applications), multiple menuing systems and specific knowledge of each application in order to know when and how to use them. This results in “islands of information” in any enterprise. The consequences of this can be lost opportunity, reinvention and rework, and unproductive time spent searching for data and other information about the enterprise and its human, tangible, and intangible resources and assets. One of the principle tasks of system integration is to integrate disparate databases, applications, and platforms into one system that is accessible to desired enterprise employees. Almost without exception, in these situations many established software systems that may have already been installed are replaced by systems that fit within the integrator's new integration scheme. Presently, it is not possible, without rewriting or replacing all the existing systems, to integrate the different applications and platforms inside the corporation. Unfortunately, when this occurs, there is the need to retrain the employees who used the previously existing systems. With the conventional methods of integrating the need for different software systems to be useable by different users for many different applications, many other limitations also exist. The existing enterprise applications and platforms are not network connectable using the various protocols, such as TCP/IP that permit communication on networks. In addition, the many applications and platforms that an enterprise uses in their present state require different and separate passwords. Even though a system integrator may provide new software systems for an enterprise, there is yet a great deal of information on different databases in different formats that either does not become incorporated into the system or that does not become usable in a common or integrated format. Also, different interfaces are necessary to integrate the different applications and the different platforms. In fact, even with the best of system integration products and services, there is no ability to provide to employees and other users a single comprehensive user interface that provides an automatically updated, up-to-the-minute view of the information and processes occurring within the enterprise across its many different applications and platforms. Consequently, there is a need for a method and system that permits use of the numerous applications and data, including platforms that are disparate. There is a need for a method and system that permits a user to avoid the unnecessary complexity and frustration of having to logon to every single system of a wide-area or other network, with a separate password for each logon operation. There is the further need for a user interface providing a single menu that permits authorized users to access all information that an entire corporation holds. There is the need for a method and system that permits local application execution from a remote application library, even in the instance that the remote application library includes functional, structurally, and substantively different data bases. There is yet a further need for a method and system that provides users the ability to interface numerous intelligent and non-intelligent interfaces at the enterprise level and execute different applications on multifarious platforms.

Referring to FIG. 1 a functional block diagram of a system which includes a host computer 121, a storage device 123, an input module 125, and a feedback module 127. The functions of all of these elements can be held in a single device or the functions of each can be distributed over multiple devices. Such devices can be local to each other or distributed remotely over a wireless or wireline, local or wide area network. Embodiments of the invention may contain additional elements not presented or may not include all of the elements presented here. The host computer 121 can comprise any number of computers including laptops, desktops, and server configurations. The host computer 121 is connected to the storage device 123 and can store and retrieve various data to and from the storage device 123. The storage device 123 may comprise any number of various media for storing data. The data stored may include patient files including patient information and charts, an educational library including print materials such as authoritative articles and published facts and multimedia clips such as video, audio, and graphics clips. Treatment options and other pre-set options may also be stored. Such options can control the course of examination and what types of feedback are provided to the patient. A practitioner may preset such options for each user, each patient, each input terminal, or each installation site, among other possibilities. For example, the practitioner may indicate a treatment plan to be delivered as feedback to a patient when data is collected within given parameters. The system can suggest particular treatment options to the practitioner based on published facts and the practitioner can accept, modify, or substitute different treatment options, or vary the given parameters as the practitioner's judgment directs. The input module 125 provides data to the host computer 121 via various input devices and sources. For example, the input can be from any of the input devices discussed above or can come from another controller or data source. For example, patient data may be electronically transferred from another doctor's office, or may be entered through an online form, among other possible sources. The host computer 121 can store all or some of the data collected from the input module in the storage device 123. The host computer 121 utilizes the feedback module 127 to provide feedback to patients and others in various forms. Some feedback options are depicted here, including the provision of a report, a visual display, publishing information to a website or via email, and other options. As will be obvious to those in the art, other feedback options are also available and may be used with the subject invention. As discussed above, pre-set options can be used to control the format and content of feedback provided via the feedback module 127.

Referring to FIG. 2 a display device 133 is viewed by a viewer 131, which may be an examiner, a patient, or other practitioner or staff member involved in the patients treatment.

Referring to FIG. 3 a screen image of a graphical user interface presented is only one example of an interface that may be used to collect patient data. Other configurations are possible including more, less, or different data fields and feedback elements. The example presented here relates to dental treatment of a patient, but a similar interface can be adapted relating to medical treatment.

Referring to FIG. 4 a screen image of a patient information interface has an appearance and style which is a trademark of Florida Probe Corporation. This interface is only one example. Other configurations are possible including more, less, or different data fields and feedback elements. The example presented here relates to periodontal charting, but a similar interface can be adapted for other treatments.

Referring to FIG. 5 in conjunction with FIG. 6 an integrated workstation environment for creation of the virtual patient model and diagnosis, treatment planning and delivery of therapeutics incorporates many of the hardware aspects including scanning or imaging devices 28/36 for capturing two dimensional images, such as a color digital camera or X-Ray machine. The workstation environment will preferably include scanning or imaging devices 30/36 for capturing three dimensional images and creating 3D models of the patient, including one or more of the following: laser scanners for scanning a plaster model of the teeth, optical scanner such as the OraMetrix hand-held scanner 30, CT scanner or MRI. In some instances, the scanning devices may be located at other facilities, in which case the 3D scans are obtained at another location and the 3D data is supplied to the workstation 10 over a suitable communications channel (Internet) or via a disk sent in the mail. Integration of the patient data acquisition, treatment planning and appliance design functions are facilitated by a preferred embodiment of the unified workstation 14. The workstation is provided with a plurality of image data sets 400, which can include 2D data (e.g., photographs) 402, 3D image data 404 from various 3D image sources, static models 406 of all or part of the patient's craniofacial anatomy, dynamic models 408 of all or part of the patient's craniofacial anatomy, color models 410, and possibly other types of image data. The workstation 14 includes software 314 that takes any possible combination of this image data to produce a virtual patient model 34. From this virtual patient model, the workstation in one possible embodiment includes one or more treatment planning tools or software 300 for planning treatment for the patient. These treatment planning tools could include specific software provided by vendors of treatment planning software or appliances, such as manufacturer #1 software 412, manufacturer #2 software 414, software for manufacturers #3, 4, 5, . . . at 416, 418, 420, as shown. Such software would be operable on the virtual patient model 34 and associated data sets representing the teeth as described at length herein. To provide interoperability of the software on the virtual patient model, the virtual patient model may have to have representations of the data that is compatible with the software of various vendors, which is within the ability of persons skilled in this art. Moreover, once appliance designs have been created by the various species of treatment planning software, the preferred embodiment of the workstation allows export of appliance design, tooth position data or other required outputs to any appliance manufacturer so as to allow the manufacture of a customized orthodontic appliance. In other words, if the workstation is equipped with OraMetrix treatment planning software, such software could output tooth position data, appliance design data and any other required data into a format compatible with the manufacturing requirements of any appliance manufacture. This interoperability of data formats for appliance design is shown by arrows 421. Thus, the workstation provides a conversion or formatting of appliance design data into a data set or output format specified by any one of a variety of particular appliance manufacturers. In the illustrated embodiment, the available therapeutics data sets are shown as manufacturer no. 1 data set 422 (brackets and customized wires), manufacturer no. 2 data set 426 (brackets and wires), manufacturer no. 3 data set 426 (removable aligning shells), manufacturer no. 4 data set 428 (brackets and wires), or still other sets 430. The appliance design data set is then furnished over the Internet to the vendor of such appliances for manufacture of a custom appliance. Hybrid treatment plans, as described above, are one possibility of a treatment plan that may be developed using the workstation and virtual patient model described herein. In one possible variant of the invention, the treatment planning software tools 300 are also provided at a remote location and some of the tasks of appliance design may be performed as a service by a separate workstation, such as a workstation of an appliance manufacturer. In this situation, the virtual patient model 34 could be provided to the appliance manufacturer, a proposed treatment plan is prepared and furnished to the practitioner, and after the plan is approved, the appliance manufacturer coordinates the furnishing of appliance design data to any designated appliance manufacturers that are used to furnish the custom appliance. The treatment planning software includes a set of instructions that perform a measurement function to measure distances in two or three dimensions in the virtual patient model, e.g., arch form shape measurements, and compare the measurements with reference dimensions for an “average” patient of similar age, sex, and race. These measurements could be obtained in any convenient manner, for example from textbooks, organizations, practitioners, etc. These measurement tools would be invoked during the course of treatment to compare tooth movement and current tooth position with expected positions and if deviations occur, the variances could be used as information to modify one or more aspects of the treatment plan, such as change the appliance design. The workstation includes a computing platform (general purpose computer) having a graphical user interface, a processor and a computer storage medium containing digitized records pertaining to a patient. The digitized records include image data, such as photographs, x-rays, and scan data of the teeth. The workstation further includes a set of software instructions providing graphical user interface tools for providing access to the digitized records, such as display and manipulation of the images or scan data in the form of 3D models. The workstation further includes software instructions for execution by the processor for facilitating treatment planning for a patient. While there are various ways in which practitioner may go about the process of designing a treatment plan for a patient, in a preferred embodiment of the invention certain specified tools are provided which allow a treatment plan to be developed in which constraints can be identified and the treatment plan can be developed without violation of such constraints.

Referring to FIG. 7 a screen shot from the graphical user interface of the workstation which includes a computer memory that stores, and makes available to the practitioner, records in the form of digital data pertaining to some or all of the following: the patient's clinical history, medical history, dental history, and orthodontic history as well as 2D photographs, 2D radio graphic images, CT scans, 2D and 3D scanned images, ultrasonic scanned images, and in general, non-invasive and sometimes invasive images, plus video, audio, and a variety of communication records, such notes, records of office visits, patient letters or communications, etc. All records and images are digitized. The records and images are made available through suitable user interface icons which cause display of the images and records on the user interface. The images can be combined or superimposed to create a virtual patient model that includes surface features (soft tissue) of the patient in one possible embodiment. The workstation also further maintains a comprehensive set of computer instructions providing tools in the form of icons, screen displays, windows, functions and features, accessible through the user interface of the workstation to assist the practitioner in planning the treatment. Various types of tools are contemplated; numerous examples are set forth herein.

Referring to FIG. 7 in conjunction with FIG. 6, FIG. 8 and FIG. 9 a set of tabs 450, 452, 454, 456 and 458 are provided. The tab 450 is a patient information tab which provides suitable screen displays for entering a variety of patient information, such as their name and address, dental and clinical history, insurance information, diagnostic information, names of other treating or consulting practitioners, etc. Tab 450 will be discussed in further detail below in conjunction with FIGS. 21A and 21B and FIGS. 54-58. The tab 452 is a tab whereby n the user accesses scan or other image data and accesses instructions and menus for scanning the patient with an in-vivo intra-oral scanner such as described in the previously cited OraMetrix PCT application. Tab 454 is a tab by which the user accesses the digital 3D impression of the teeth, obtained from the scanning of the patient. Tab 456 is a case management tab and includes a number of specific available screen displays and menus which are shown in the menu 460 in the lower left of the Figure. The case management tab, and its various features, is described at length in the following discussion. Additionally, there is a digital treatment planning tab 458 which provides further menus, tools and displays by which the practitioner may further move teeth and design the shape and configuration of a customized orthodontic appliance. An example of the types of menus and tools that are available in the tab 458 is the OraMetrix treatment planning software described in application Ser. No. 09/834,412, filed Apr. 13, 2001. However, it is possible to provide, in the workstation, a suite of treatment planning software from different appliance manufacturers in which case the user could access the treatment planning software for whatever appliance manufacturer the practitioner wished to use for treatment of the patient. In this situation, it may be necessary to format the tooth data in a format compatible with the appliance design and treatment planning software so as to ensure compatibility between the various systems that may be installed on the workstation. The user has selected a “treatment strategy” icon 461, which causes the display 462 to appear. In this display, there is a field 464 for the user to enter high level diagnosis and problem classification information, for example in the form of text. A field 466 is provided which provides a matrix format by which the conditions relevant to the patient's soft tissue, skeletal, and dental anatomy are entered, each with respect to vertical, sagittal, and transverse positions, again in text form. The display also includes a treatment strategy field 468 where the user will indicate the general, high level approach to treatment, such as any proposed extractions, appliance type, stages of treatment, etc. These fields 464, 466 and 468, along with displayed image data for the patient, assist the practitioner in identifying the constraints pertinent to the treatment planning.

U.S. Pat. No. 8,639,526 teaches systems for diagnosis of and early treatment adoption for asymptomatic diseases. An examination system includes an input device for entering patient data, a computer including a medium for storing entered data, and a feedback module for providing feedback to an examined patient based on the data entered. Feedback is provided directly to the patient concurrently with the measurement or other acquisition of a significant data point. Feedback is also provided at the conclusion of the examination in the form of a report, treatment plan, or customized educational materials. The patient is an active participant in the examination, recording data points themselves via the input device. A variety of relatively inexpensive treatment options for periodontal disease are emerging. But many of these treatment options are only indicated when the disease is in its early stages. Later, treatment options become increasingly invasive and expensive, often requiring oral surgery and/or treatment of the associated problems caused by the periodontal disease. Therefore, early detection and treatment of periodontal disease is important to ensure the best outcomes and decrease health care costs. Unfortunately, current methods of early diagnosis of periodontal disease are underutilized, cumbersome, and/or prone to errors. For example, voice activated periodontal charting systems are available that allow a registered dental hygienist or other trained examiner to document periodontal disease during examination. But these systems must be trained to the voice of the particular examiner and can introduce errors into the patient's chart. In a periodontal examination producing 500-1000 data points, an error rate of just 4% produces 20-40 errors per examination. These errors must either be corrected in front of the patient or left uncorrected. Other available systems provide automated voice confirmation to detect and correct errors, but these systems provide no feedback or education to the patient. For example, U.S. Pat. No. 7,329,116 teaches a foot-operated data entry device including an automated voice system, but the voice system merely announces data values to be entered into a computer-based chart. The system merely repeats the data entered via the input device without any additional feedback or educational messages for the patient. Such feedback and education is critical because, unlike other dental problems, early periodontal disease is often not accompanied by pain or visible symptoms that inform the patient of the seriousness of the problem. Hygienists and other dental professionals have a difficult time convincing patients to treat a problem they can neither see nor feel. The normative roles of different participants in the examination and diagnosis process can also be a barrier to early treatment adoption. Often times persons who have the most interaction with a patient, such as nurses, assistants, and hygienists, develop an emotional attachment to the patient. This type of caring open relationship is important to patient care as well as to the success of a practice. But, if the nurse, hygienist, or other representative of the practice becomes reluctant to deliver “bad news” to the patient because of this attachment, the patient's care may suffer and the practice may be exposed to liability for failure to properly inform the patient of their condition and associated risks. The changing normative role of doctors, dentists, and other licensed professionals can also become a barrier to treatment when a patient's expectations are not met. Younger generations of patients may be less prone to respect a professional's authority without question. These patients may seek a more in-depth understanding of their condition and treatment options. Such patients increasingly seek out other sources of information on their own via high-technology sources, such as the Internet, or require more information from their doctors or other dental and health care professionals. Professionals who have been practicing a long time may not be accustomed to being questioned in depth by this new generation of patients. They may consider such activities as “selling” a patient on a treatment. They may feel that sales interaction with a patient is undignified and inappropriate for a professional. But if professionals do not respond well to a patient's inquires, the patient may take their questions elsewhere, or worse, rely on a misunderstanding of information they themselves find on the Internet. Again, patient care may suffer and a practice may be exposed to liability as a result. There is need for a less cumbersome method for periodontal examination that also educates patients and encourages early treatment adoption. There is also need for an authoritative, unbiased, third-party “voice” in a practice that can deliver in-depth, customized condition and treatment information to patients in a manner that is efficient, engaging, effective, consistent, and documentable, without risking caring patient relationships. Periodontal disease is highlighted here as an illustrative example of an asymptomatic disease that would benefit form early diagnosis and treatment adoption. The subject invention can also be applied to other medical diseases.

U.S. Pat. No. 8,469,705 a workstation for orthodontic treatment planning of a patient which is based on a computing platform having a graphical user interface, a processor and a computer storage medium containing digitized records pertaining to a patient including image data (3D image data and/or 2D image data). The workstation includes a set of software instructions providing graphical user interface tools which the user marks a midline and an aesthetic occlusal plane in a two- or three-dimensional virtual model of the patient, marks an occlusal plane in the virtual model; selects a reference tooth in the virtual model; aligns virtual teeth in the virtual model in a proposed arrangement to treat the patient; manages space between the virtual teeth in the proposed arrangement; and repeats one or more of these steps in an iterative fashion to make any further adjustments in the proposed arrangement. When the adjustments are complete, the user selects or identifies a finalized proposed treatment plan for treating the patient. The traditional process of diagnosis and treatment planning for a patient with orthodontic problems or disease typically consists of the practitioner obtaining clinical history, medical history, dental history, and orthodontic history of the patient supplemented by 2D photographs, 2D radio graphic images, CT scans, 2D and 3D scanned images, ultrasonic scanned images, and in general non-invasive and sometimes invasive images, plus video, audio, and a variety of communication records. Physical models, such as made from plaster of paris, of the patient's teeth are created from the impressions taken of the patient's upper and lower jaws. Such models are manually converted into teeth drawings by projecting teeth on drawing paper. There is a large volume of images and data involved in the diagnosis and treatment planning process. The information may require conversion from one form to another and selective reduction before it could become useful. There are some computerized tools available to aid the practitioner in these data conversion and reduction steps to convert cephalometric x-rays (i.e., 2 dimensional x-ray photographs showing a lateral view of the head and jaws, including teeth) into points of interest with respect to soft tissue and hard tissue, but they are limited in their functionalities and scope. Even then, there is a fairly substantial amount of manual work involved in these steps. A number of measurements, e.g., available space between teeth, are also often done manually. Generally, these steps are time consuming and prone to inherent inaccuracies. Furthermore, the practitioner has to contend with the biological interdependencies within the patient, which introduces constraints eliminating certain treatment options that would otherwise be acceptable, between the soft tissue, the hard tissue, and the teeth. There is lack of an integrated platform which a practitioner could utilize to filter-out non-practicable treatment options. Consequently, the practitioner is left to mental visualization, chance process to select the treatment course that would supposedly work. The diagnosis process is some-what ad-hoc and the effectiveness of the treatment depends heavily upon the practitioner's level of experience. Often, due to the complexities of the detailed steps and the time consuming nature of them, some practitioners take a short-cut, relying predominantly on their intuition to select a treatment plan. For example, the diagnosis and treatment planning is often done by the practitioner on a sheet of acetate over the X-rays. All of these factors frequently contribute towards trial and error, hit-and-miss, lengthy and inefficient treatment plans that require numerous mid-course adjustments. While at the beginning of treatment things generally run well as all teeth start to move at least into the right direction, at the end of treatment a lot of time is lost by adaptations and corrections required due to the fact that the end result has not been properly planned at any point of time. By and large, this approach lacks reliability, reproducibility and precision. More over, there is no comprehensive way available to a practitioner to stage and simulate the treatment process in advance of the actual implementation to avoid the often hidden pitfalls. And the patient has no choice and does not know that treatment time could be significantly reduced if proper planning was done. In recent years, computer-based approaches have been proposed for aiding orthodontists in their practice. However, these approaches are limited to diagnosis and treatment planning of craniofacial structures, including the straightening of teeth. A method for generation of a 3D model of the dentition from an in-vivo scan of the patient, and interactive computer-based treatment planning for orthodontic patients, is described in published PCT patent application of Ora-Metrix, Inc., the assignee of this invention, publication no. WO 01/80761 the contents of which are incorporated by reference herein.

Other background references related to capturing three dimensional models of dentition and associated craniofacial structures include S. M. Yamany and A. A. Farag, “A System for Human Jaw Modeling Using Intra-Oral Images” in Proc. IEEE Eng. Med. Biol. Soc. (EMBS) Conf, Vol. 20, Hong Kong, October 1998, pp. 563-566; and M. Yamany, A. A. Farag, David Tasman, A. G. Farman, “A 3-D Reconstruction System for the Human Jaw Using a Sequence of Optical Images,” IEEE Transactions on Medical Imaging, Vol. 19, No. 5, May 2000, pp. 538-547. The contents of these references are incorporated by reference herein. The technical literature further includes a body of literature describing the creation of 3D models of faces from photographs, and computerized facial animation and morphable modeling of faces. See, e.g., Pighin et al., Synthesizing Realistic Facial Expression from Photographs, Computer Graphics Proceedings SIGGRAPH '98, pp. 78-94 (1998); Pighin et al., Realistic Facial Animation Using Image-based 3D Morphing, Technical Report no. UW-CSE-97-01-03, University of Washington (May 9, 1997); and Blantz et al., A Morphable Model for The Synthesis of 3D Faces, Computer Graphics Proceedings SIGGRAPH '99 (August, 1999). The contents of these references are incorporated by reference herein.

The treatment design as described herein also allows for real-time communication of the treatment plan to occur with the patient, or transmitted over a communications link and shared with a colleague or remote appliance manufacturing facility. Alternatively, the treatment planning can be performed remotely and a digital treatment plan sent to the orthodontist for review, interactive modification, or approval. To more accurately map the two-dimensional images of a tooth onto the three-dimensional model, multiple angles of the tooth should be used. Accordingly, a side, a front, and a bottom view of the tooth should be taken and mapped to the scaled digital model of the tooth. Note that the bone and other portions of the orthodontic structure are scaled in a similar manner. Further note that MRI images, and any other images obtained of the orthodontic patient, may also be scaled in a similar manner. A more complete representation of the tooth roots may be obtained using standardized, template 3D virtual tooth roots, applying the X-Ray data to the template tooth roots and modifying their shape accordingly, and them applying the modified template tooth root to the scan data of the crown to create a scaled, complete virtual tooth object including tooth roots.

The inventor hereby incorporates the above-referenced patents and patent publication into his specification.

### SUMMARY OF THE INVENTION

The present invention is a combination dental imaging system and dental practice management and charting system. The combination includes a web browser based dental practice management software having patient charting capabilities and an encapsulated web browser based dental imaging software component which includes a display of images suitable for diagnostic use. The combination also includes a communication interface which couples the web browser based dental imaging software component to the web browser based dental practice management system software.

In a first aspect of the present invention an encapsulated web browser based dental imaging software component is embedded into a disparate dental practice management system software web page.

In a second aspect of the present invention the encapsulated decoupled web browser based dental imaging software component is decoupled and embedded with the disparate web browser based dental practice management software to visually create the appearance of a single web page.

In a third aspect of the present invention the web browser based dental practice management system software graphical user interface is updated with the capability to initiate display of the encapsulated web browser based dental imaging software component.

In a fourth aspect of the present invention the encapsulated decoupled web browser based dental imaging software is decoupled and embedded using a HTML frame with a disparate web browser based dental practice management software to visually create the appearance of a single web page.

In a fifth aspect of the present invention the encapsulated web browser based dental imaging software is decoupled and embedded using a HTML DOM (Document object Model) with a disparate web browser based dental practice management software to visually create the appearance of a single web page.

In a sixth aspect of the present invention the encapsulated web browser based dental imaging software is decoupled and embedded using a HTML frame component with a disparate web browser based dental practice management software to allow display of diagnostic images from within a web browser based dental practice management software and which images were generated by the encapsulated decoupled web browser based imaging software.

In a seventh aspect of the present invention the encapsulated web browser based dental imaging software is decoupled and embedded using a HTML DOM (Document object Model) with a disparate web browser based dental practice management software to allow display of diagnostic images from within a web browser based dental practice management software and which images were generated by the encapsulated decoupled web browser based imaging software.

In an eighth aspect of the present invention the encapsulated web browser based dental imaging software is decoupled and embedded using a HTML frame component; with a disparate web browser based dental practice management software; for the purpose of allowing imaging capability from within the dental practice management software, while simultaneously preventing the dental practice management software from being considered a FDA medically regulated product

In a ninth aspect of the present invention an encapsulated web browser based dental imaging software is decoupled and embedded using a HTML DOM (Document object Model) component; with a disparate web browser based dental practice management software; for the purpose of allowing imaging capability from within the dental practice management software, while simultaneously preventing the dental practice management software from being considered a FDA medically regulated product.

Other aspects and many of the attendant advantages will be more readily appreciated as the same becomes better understood by reference to the following detailed description and considered in connection with the accompanying drawing in which like reference symbols designate like parts throughout the figures.

### DESCRIPTION OF THE DRAWINGS

FIG. 1 shows a functional block diagram of a system in accordance with U.S. Pat. No. 8,639,526.

FIG. 2 shows a display device in accordance with U.S. Pat. No. 8,639,526.

FIG. 3 shows a screen image of a graphical user interface in accordance with U.S. Pat. No. 8,639,526.

FIG. 4 shows a screen image of a patient information interface in accordance with U.S. Pat. No. 8,639,526.

FIG. 5 is a detailed block diagram of the treatment planning software executed by the workstation in accordance with U.S. Pat. No. 8,469,705.

FIG. 6 is an illustration of the integration of the patient data acquisition, treatment planning and appliance design functions that are facilitated in accordance with U.S. Pat. No. 8,469,705.

FIG. 7 illustrates a first screen shots from the workstation showing various treatment planning features that are provided by the treatment planning software of FIG. 5 in accordance with U.S. Pat. No. 8,469,705.

FIG. 8 illustrates a second screen shots from the workstation showing various treatment planning features that are provided by the treatment planning software of FIG. 5 in accordance with U.S. Pat. No. 8,469,705.

FIG. 9 illustrates a third screen shots from the workstation showing various treatment planning features that are provided by the treatment planning software of FIG. 5 in accordance with U.S. Pat. No. 8,469,705.

FIG. 10 is a photograph in color of a chart generated by a prior art dental practice management system using software which includes charting capabilities.

FIG. 11 is a photograph in color of a thumbnail in the dental practice management system of FIG. 10.

FIG. 12 is a photograph in color of a disparate non-FDA regulated dental practice management system using software and a charting module.

FIG. 13 is a photograph in color of disparate encapsulated dental imaging system of FIG. 12 which uses a software component embedded into the non-FDA regulated dental practice management system software in accordance with the present invention.

FIG. 14 shows a flowchart containing the steps of the method for one embodiment of the present invention.

FIG. 15 shows a flowchart containing steps of the method for a second embodiment of the present invention.

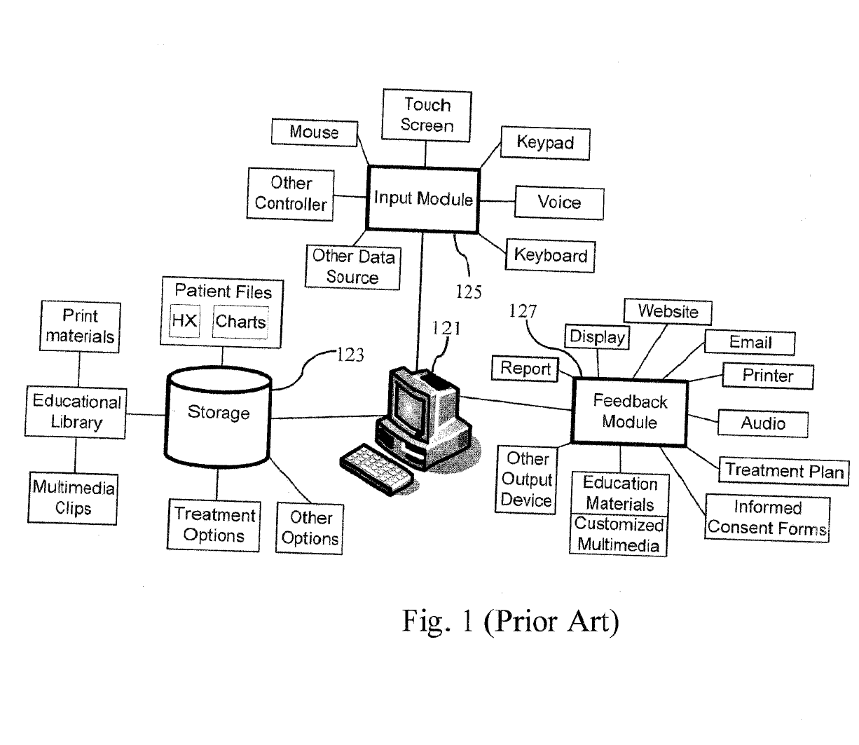

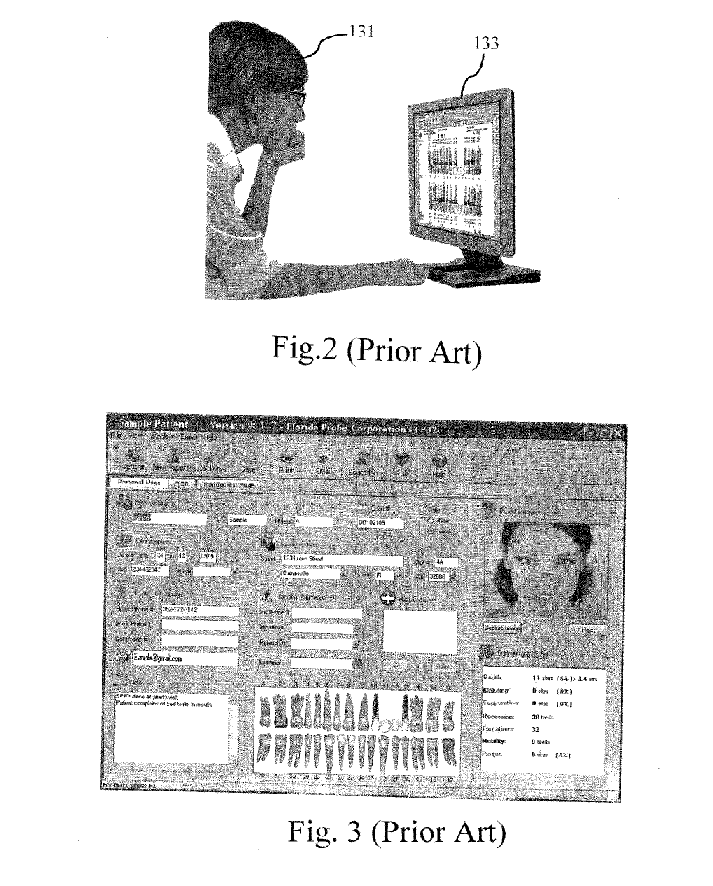

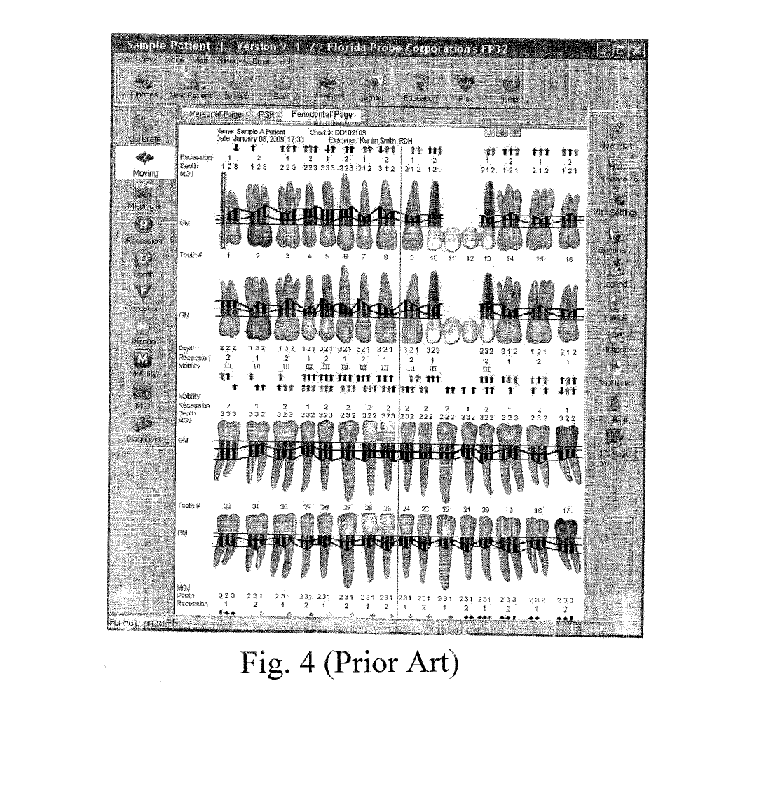

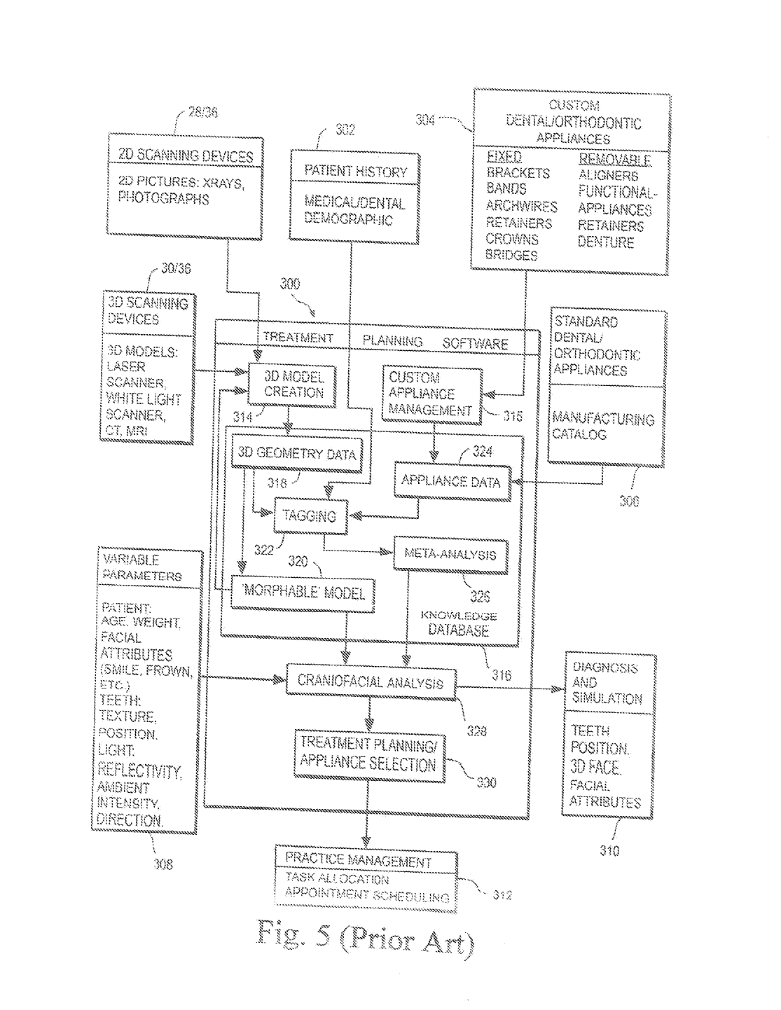

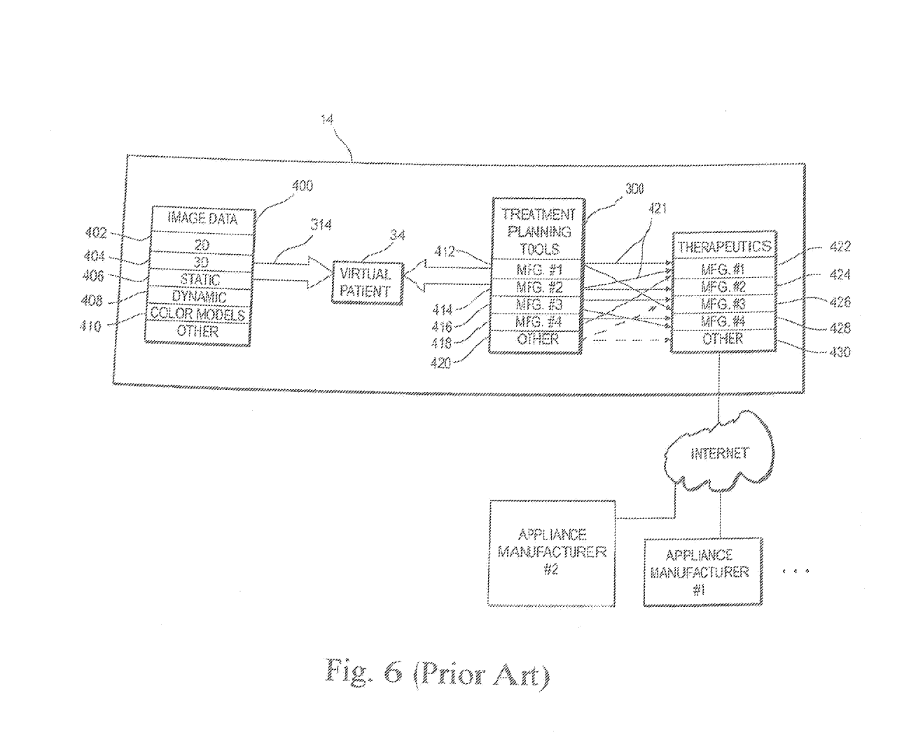

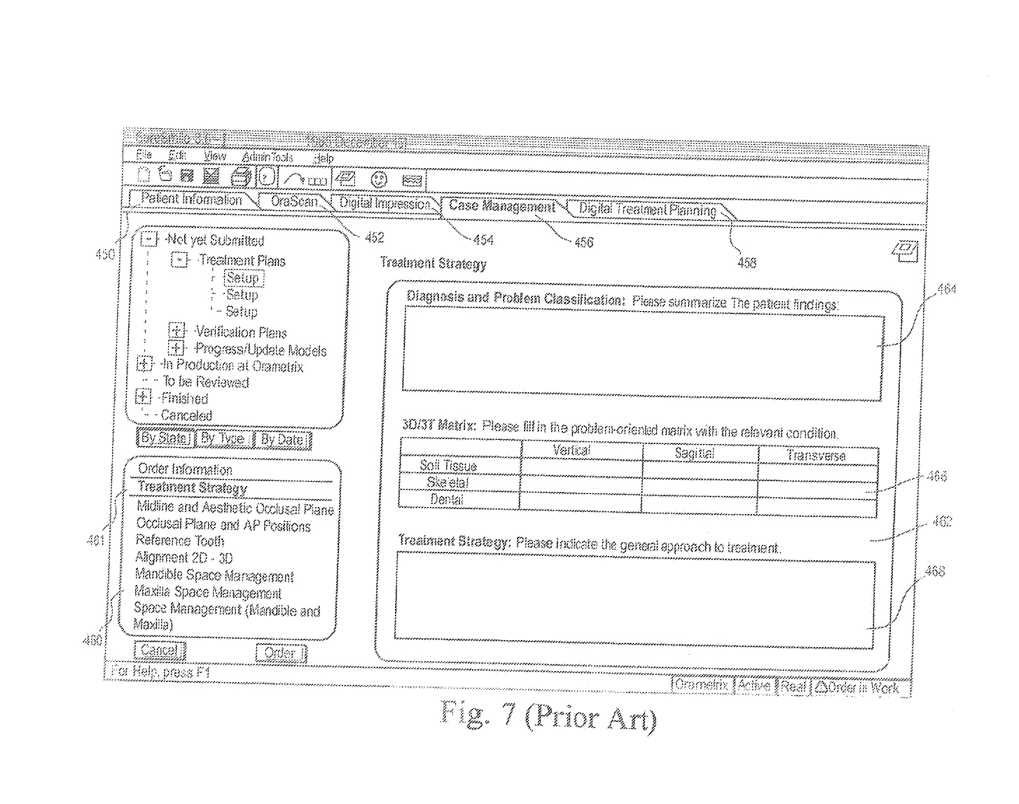

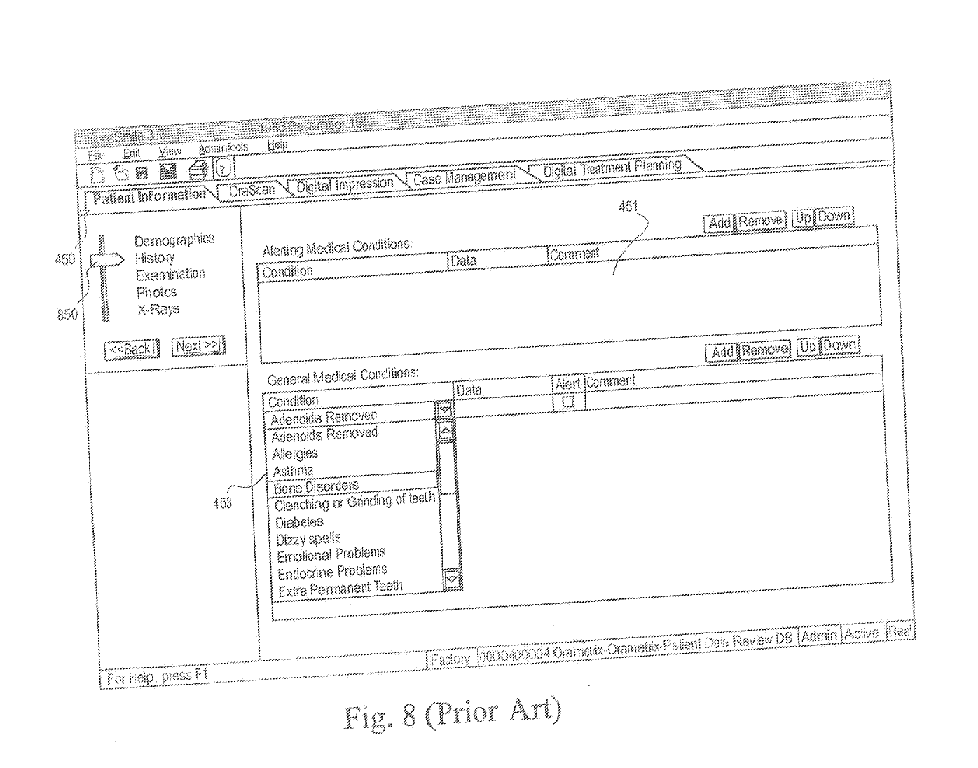

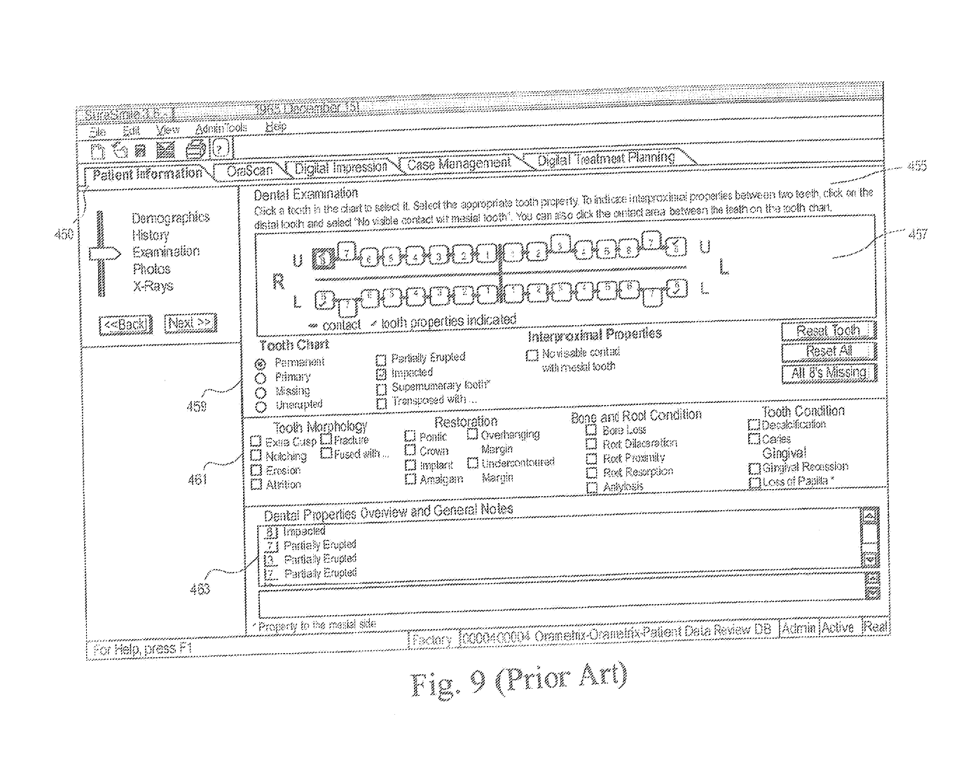

### DESCRIPTION OF THE PREFERRED EMBODIMENT

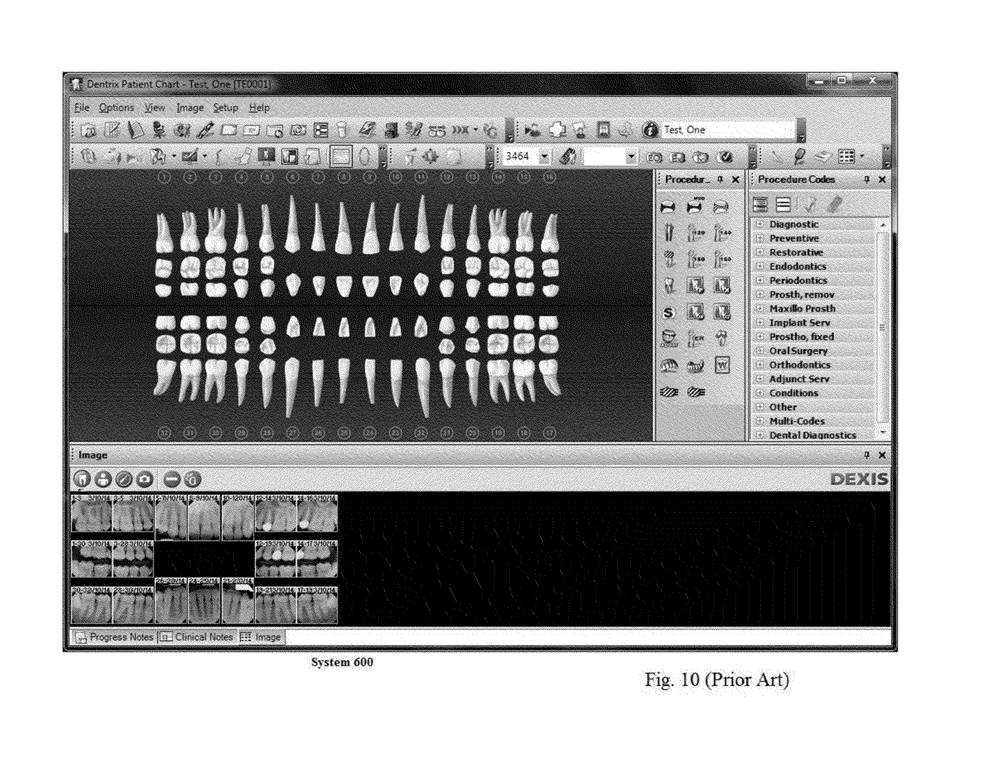

Referring to FIG. 10 a dental practice management system 600 includes integration with disparate dental imaging system software by displaying a window containing non-diagnostic thumbnails of images generated by the disparate dental imaging system software which can be user selected.

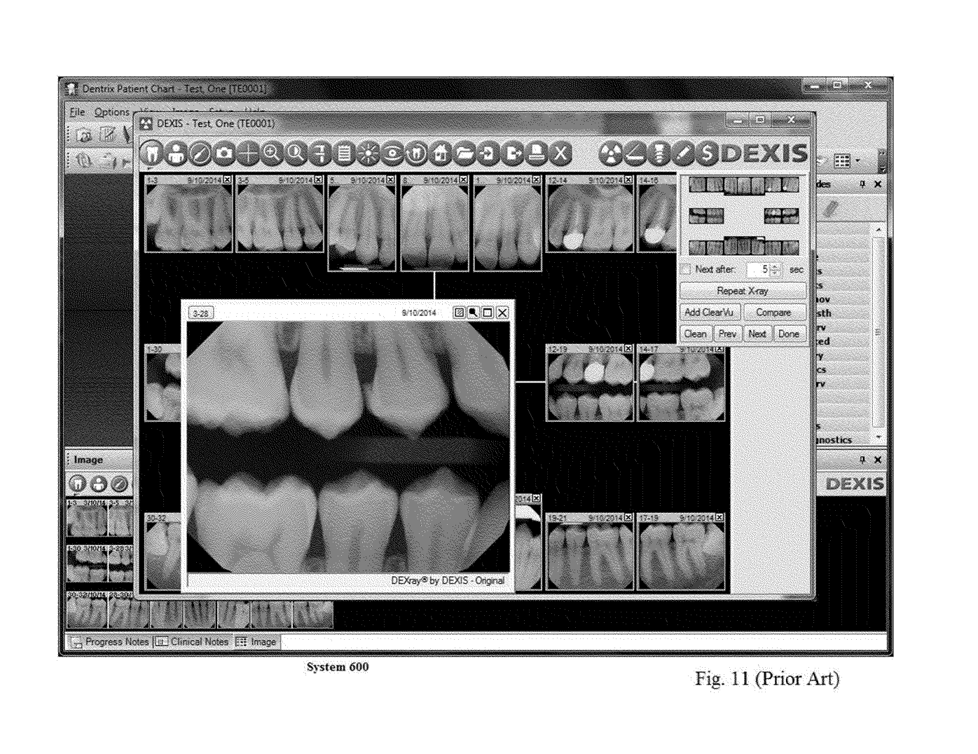

Referring to FIG. 11 upon a user's selection of a thumbnail in the dental practice management system 600 disparate dental imaging system software is enacted and its application window and graphical user interface are displayed on top of the dental practice management system's software application window. A diagnostic quality image is then displayed and used for diagnosis in the separate dental imaging system software window.

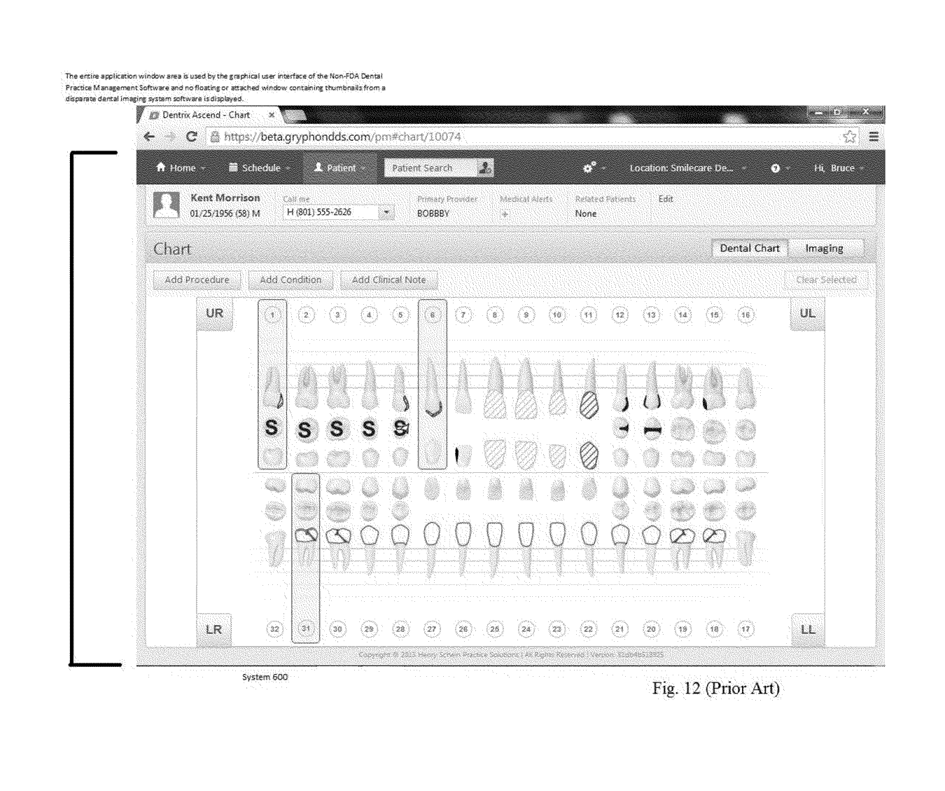

Referring to FIG. 12 the disparate non-FDA regulated dental practice management system uses software and a charting module and does not display a floating or attached window of thumbnails generated by a disparate dental imaging system software. The disparate non-FDA regulated dental practice management system utilizes a frame or DOM to embedded dental imaging system software component into the disparate non-FDA regulated dental practice management system software and allows full imaging capabilities from within the dental practice management system.

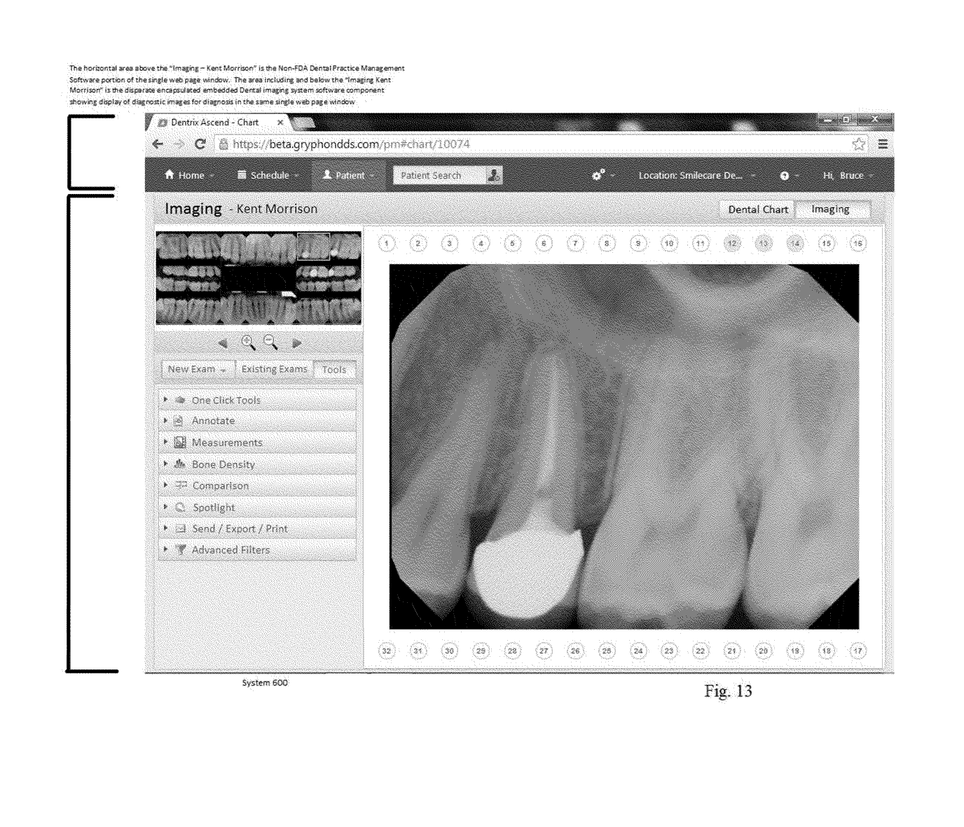

Referring to FIG. 13 the encapsulated dental imaging system 600 has a software component which includes display of diagnostic images for diagnosis which were generated by the encapsulated dental imaging system software from within the same non-FDA regulated dental practice management software application window; and which allows seamless flow between two disparate modules from within a single application window.

The issues, noted above, related to combining and automating two separate disparate software have been overcome. One being a non-FDA regulated web browser based dental practice management software and the other being a FDA regulated web browser based dental imaging software. Our method allows seamless unified interaction between the two disparate web browser based software's; and offers visually to the user, a single web page appearance containing both the practice management software output and the dental imaging software output. Our novel method embeds a encapsulated decoupled FDA regulated web browser based dental imaging software into a separate disparate Non-FDA regulated web based dental practice management software using an frame and/or a DOM (Document Object Model) component to isolate regulated source code from non-regulated source code. Our method of encapsulating full diagnostic web browser based dental imaging software functionality into a frame or DOM allows 100% imaging source code isolation of the FDA regulated dental imaging software from the dental practice management software source code. Embedding an encapsulated decoupled dental web browser based imaging software into a disparate web browser based dental practice management software allows users to have full dental imaging software capabilities including acquisition, editing, and diagnosis directly accessible from within the dental practice management software, while simultaneously offering a single unified web page appearance created from two disparate web browser based software's, and simultaneously prevents the dental practice management software itself from becoming a regulated medical device software. The present invention generally relates to seamlessly combining dental imaging software with dental practice management software and more particularly to a method of embedding a de-coupled FDA regulated medical device encapsulated web browser based dental imaging software component into a disparate non-FDA regulated web browser based dental practice management software for the purpose of appearing as a single unified web page, allowing full imaging capabilities to be accessed by the practice management software, and prevention of the practice management software from becoming FDA regulated software.

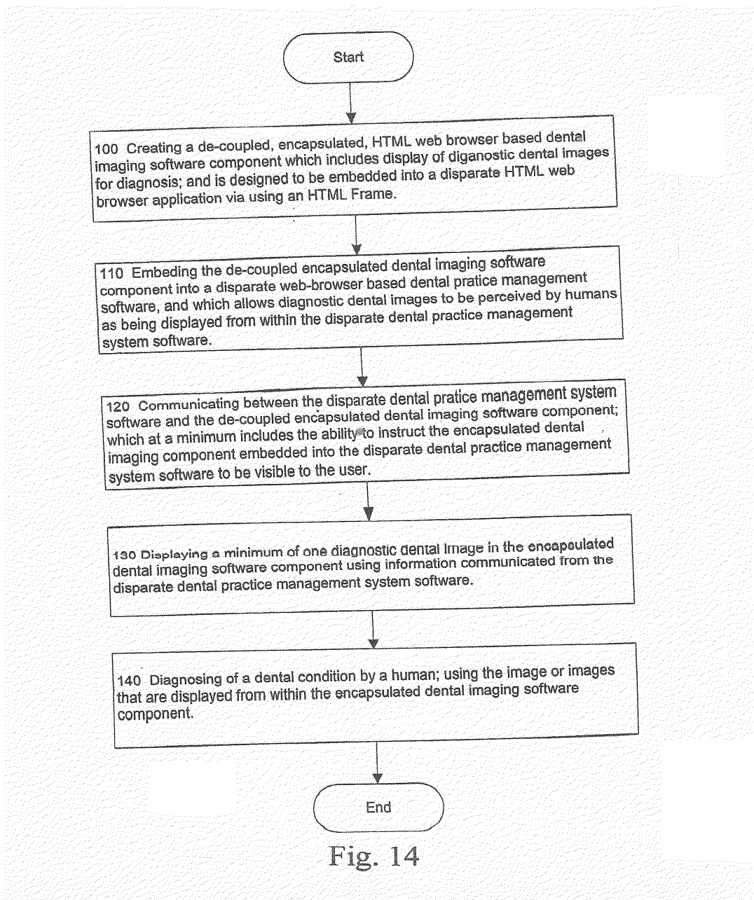

Referring to FIG. 14 a flowchart contains the steps of the method for a first embodiment of the present invention.

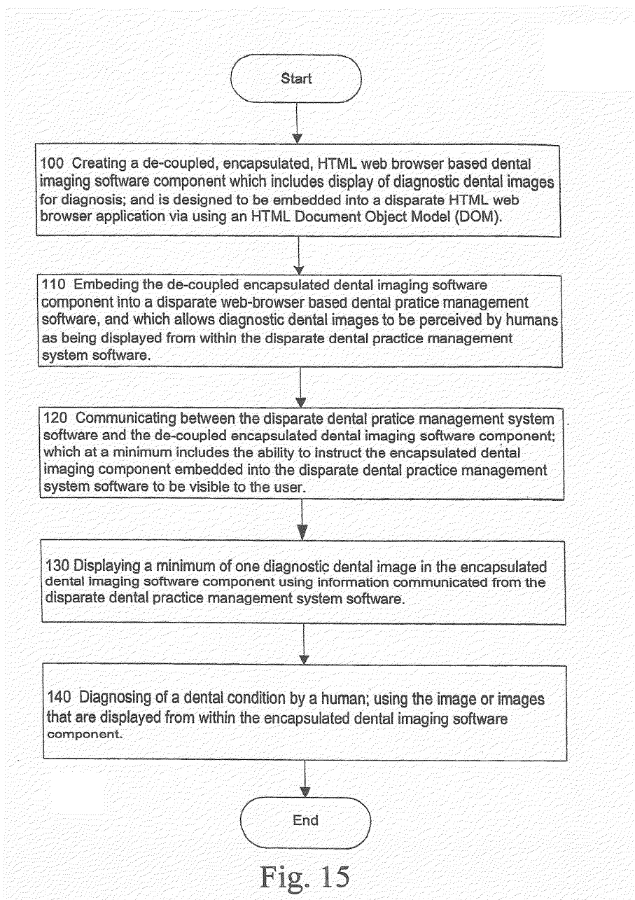

Referring to FIG. 15 a flowchart contains the steps of the method for a second embodiment of the present invention.

Accordingly it is intended that the foregoing disclosure and showing made in the drawing shall be considered only as an illustration of the principle of the present invention.

What is claimed is:

1. A combination dental imaging system and dental practice management and charting system comprising:
a. a web browser based dental practice management software which includes patient charting capabilities;
b. an encapsulated web browser based dental imaging software component wherein said encapsulated dental imaging software component includes a display of images suitable for diagnostic use and wherein said encapsulated web browser based dental imaging software component is embedded into a disparate dental practice management system software web page; and
c. a communication interface which couples said web browser based dental imaging software component to said web browser based dental practice management system software wherein said web browser based dental practice management system software graphical user interface is updated with the capability to initiate display of said encapsulated web browser based dental imaging software component.

2. A combination dental imaging system and dental practice management and charting system according to claim 1 wherein said encapsulated web browser based dental imaging software component is embedded into said disparate dental practice management system software web page via using an HTML frame component.

3. A combination dental imaging system and dental practice management and charting system according to claim 1 wherein said encapsulated web browser based dental imaging software component is embedded into said disparate dental practice management system software web page via using an HTML Document object Model (DOM) component.

4. A computer implemented method for embedding a web browser based dental imaging software component into a disparate web browser based dental practice management system software, said method includes the steps of:
a. creating a web browser based dental imaging software which includes diagnostic display of dental images;
b. encapsulating said web browser based dental imaging software into a component which can be embedded into a disparate web page;
c. embedding said web browser based dental imaging software component into a web browser based dental practice management or charting system software using an HTML frame component; and
d. updating the web based practice management system software graphical user interface with the capability to initiate display of said encapsulated web browser based dental imaging software component.

5. A computer implemented method for embedding a web browser based dental imaging software component into a disparate web browser based dental practice management system software according to claim 4 wherein said step of embedding said web browser based dental imaging software component into a web browser based dental practice management or charting system software uses an HTML frame component.

6. A computer implemented method for embedding a web browser based dental imaging software component into a disparate web browser based dental practice management system software according to claim 4 wherein said step of embedding said web browser based dental imaging software component into a web browser based dental practice management or charting system software uses an HTML Document object Model (DOM) component,
